(19) United States
(12) Patent Application Publication
(10) Pub. No.: US 2025/0005515 A1
(43) Pub. Date: Jan. 2, 2025

(54) ADVANCED MERCHANDISING AND SHELF RESTOCKING SYSTEM AND METHOD

(71) Applicant: Spot It. Ltd., Guelph (CA)

(72) Inventors: Caleb OPERSKO, Guelph (CA); Andre BELISLE, Puslinch (CA); Mohannad HUSSAIN, Waterloo (CA); Ali ZEROUAL, Orleans (CA)

(21) Appl. No.: 18/709,069

(22) PCT Filed: Nov. 11, 2022
(86) PCT No.: PCT/CA2022/051672

§ 371 Date: May 10, 2024

Related U.S. Application Data
(60) Provisional application No. 63/278,259, filed on Nov. 11, 2021.
(60) Provisional application No. 63/312,131, filed on Feb. 21, 2022.

(51) Int. Cl. G06Q 10/087; G06F 3/0481; G06F 3/04842; G06Q 10/067

(52) U.S. Cl. CPC G06Q 10/087; G06F 3/0481; G06F 3/04842; G06Q 10/067

(57) ABSTRACT

A system and method of advanced merchandising and shelf restocking. The system allows merchants to embellish static retail section plans or “planograms” and digitize them in an interactive way for a variety of tasks. The system shows which products/components should be removed and provides an efficient way of indicating products for restocking. This system can also be used to create analytical reports based off historic data or via data imported from outside sources so long as it relates to what is stored in the virtual plan. Other aspects of the system include the addition of merchandising notes, auditing photo capture, color coding for instructions, a comprehensive logging mechanism, and other improvements.

### CROSS REFERENCE TO RELATED APPLICATIONS

This application incorporates aspects of U.S. Provisional Application No. 63/278,259 entitled “Merchandising and Shelf Restocking System” filed on Nov. 11, 2021, and U.S. Provisional Application Ser. No. 63/312,131 entitled Merchandising and Shelf Restocking System” filed on Feb. 21, 2022, the disclosures of which are incorporated herein by reference in its entirety. This application is also a national phase entry of PCT Application PCT/CA2022/051672 entitled “Advanced Merchandising and Shelf Restocking System and Method” filed on Nov. 11, 2022.

### BACKGROUND

The embodiments described herein relate to merchandising displays and sections setup aids.

There are many aspects of in-store retailing which are in need of innovation. Many retailers and the companies which service them use paper methods for a variety of tasks, including the building and remerchandising of sections within a store.

Stores frequently change their layouts, inventory or focus, and new stores are often opening, necessitating putting products into their allocated sections. Typically, this work is performed by store staff, or by companies (i.e., contractors or consultants) hired specifically for this work. Less time spent on this work reduces overall costs, but inaccurate work (often coming when personnel are rushed) may necessitate the redoing of the work, at high cost. As manufacturers and brand companies pay for shelf space, the work must be done accurately, and as the work may disrupt the regular retail functioning of the store, it must be completed quickly.

Typically, this remerchandising or building of shelves is performed using a static, paper-based plan. The plan must first be created, usually manually, and barcodes or SKUs noted on the plan. The person tasked with building the retail fixture must then proceed shelf location by shelf location, identifying whether the product in that location must be changed, finding the product to replace it with (if necessary) and then stocking the item in the shelf. This is laborious work, as the plan may only show SKUs, and the worker then needs to locate the product corresponding to that SKU in their supply.

### SUMMARY

The system described herein allows merchants to embellish static retail section plans or “planograms” and digitize them in an interactive way for a variety of tasks. The dynamic nature of the visualization tool's display allows much faster and more accurate stocking of products. The central system and API first compare a new retail plan against any older, existing one. The user would then first see a visual display of what components or products need to be removed and which ones will remain. Then as components or products need to be placed in their locations, the user initiates a search with that component or product's unique identifier. The central API then searches for that unique identifier in the stored retail plan and highlights the necessary visual component in the displayed digital version of the plan. If that unique identifier is not found, the central API then searches any associated database for any metadata that is connected to the unique identifier. Should there be connected metadata, the API then searches for it in the digital plan and then either highlights the necessary visual component or returns an error. This system can also be used to create analytical reports based off historic data or via data imported from outside sources so long as it relates to what is stored in the virtual plan.

The beginning and end times of the deployment are ascertained by the system. The system allows a handheld or laptop-based tool to track the duration of a deployment. The system also enables color-coding on the display, with the color selection tied to specific commands. The duration of the deployment is added to a database, to create a historical record which may be used to estimate the duration of subsequent similar or identical deployments. Once the deployment session is finished, the system can detect which products were required in the deployment but were not scanned during the session, which information may be compiled into a report, and which information may be used to order or ship missing products to complete the deployment as originally planned. Additionally, a notes feature allows a controller to provide notes for the merchandiser (the worker performing the deployment). These notes provide further information on the deployment, and may consist of text, images, or audio/visual material. A photo of the finished deployment, captured by the device, taken by the merchandiser, allows for back-end checking of the status and accuracy of the deployment.

### DESCRIPTION OF THE DRAWINGS

FIG. 1 is a flowchart for how the tool shows which products should be removed from the shelf and which ones should stay.

FIG. 2 is a flowchart for the method by which the central API searches the plan or map, and subsequently associated databases, to find the input identifier.

FIG. 3 is a view of one embodiment of the user interface for the visualization tool.

FIG. 4 is a view of another embodiment of the user interface for the visualization tool.

FIG. 5 is a view of one embodiment of the user interface for the map/plan editor.

FIG. 6 is a view of one embodiment of a user interface to log into the system on the mobile device or laptop.

FIG. 7 is a view of one embodiment of the initial user interface for a deployment rebuild.

FIG. 8 is a view of one embodiment of the user interface for beginning a deployment session.

FIG. 9 is a view of one embodiment of the user interface for the visualization tool showing a command referencing a single section for a product.

FIG. 10 is a view of one embodiment of the user interface for the visualization tool showing multiple commands referencing multiple sections for a product.

FIG. 11 is a view of one embodiment of the user interface for the visualization tool for ending a deployment session.

FIG. 12 is one embodiment of a deployment report that may be generated by the system.

FIG. 13 is a view of one embodiment of the user interface for estimating the duration of a deployment session.

FIG. 14 is a view of one embodiment of the user interface for creating or editing a planogram, where a note may be entered for the merchandiser.

FIG. 15 is a view of one embodiment of the user interface for the visualization tool showing a note for the merchandiser.

FIG. 16 is a flowchart of the workflow between a merchandiser and the merchandising system, relating to taking a picture of the completed deployment.

FIG. 17 is a view of one embodiment of the user interface for the visualization tool showing the overlay for taking a picture of the completed deployment.

FIG. 18 is a view of one embodiment of the user interface for the visualization tool for taking a picture of the completed deployment.

FIG. 19 is a view of one embodiment of the user interface for the maintenance tool.

FIG. 20 is a view of one embodiment of the user interface for the maintenance tool for checking on a specific product in a deployment.

FIG. 21 is one embodiment of an audit report that may be generated by the system.

### DETAILED DESCRIPTION

This application discloses enhancements to a visualization tool and an optional system for creating a planogram as input for the visualization tool.

The system for creating the planogram may be a map editor, a plan editor, or some other system for creating a planogram. This editor may be further broken down into two parts: storing components and non-storing components. Storing components are the visual components that can store information such as SKUs (product identifiers), UPCs (barcodes) or any other unique identifier. These storing components are used to denote things such as fixtures, signage, or product locations. Non-storing components are things such as lines that are there solely for visual purposes. When the plan is being built, the creator of the plan may also need to add the necessary information for the components and products so that they can be searched for. This information may instead be automatically generated or imported from a database.

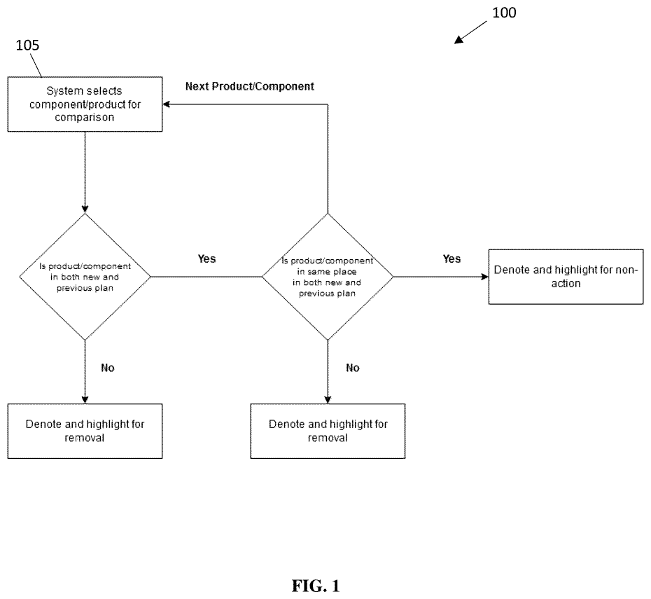

The visualization tool can take the form of a general-purpose computing system, such as a laptop or mobile phone, running a program or app, or viewing a webpage; or the tool may be implemented within a use-specific package such as a dedicated handheld tool. Here the digitized plan or “planogram” is displayed continuously, and components are highlighted when needed. The user would first get a report showing which current components/products need to be removed for the new plan. FIG. 1 shows the flowchart 100 of steps taken by the system to create this report, beginning with the system selection step 105, and making a decision for each product/component, resulting in a dual- or multi-colored report showing the user which products/components should be removed. The user would then remove the necessary components/products from the shelf first. As the user is ready to place or “merchandise” the new components/products, they would start to use the search function of the tool. Whichever input method is used, a search is initiated based on a component/product's unique identifier. This unique identifier can take the form of a barcode, a SKU number or any other number, key or identifying information to uniquely identify a component/product.

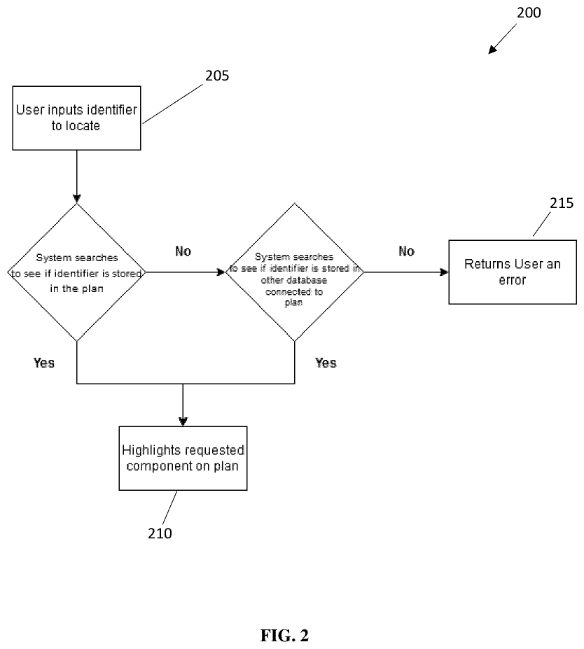

When the search is initiated, the central API then begins to search for the unique identifier. FIG. 2 shows the flowchart 200 of steps taken by the system, for each product, to find, map and highlight the product linked to the identifier which the user has input, beginning with a user input step 205, and ending with either highlighting the requested product or component on the plan 210 or returning an error to the user 215. The unique identifier may not be stored in the map; for example, in one implementation, a location code is stored in the map. In such a case, a database may store a mapping between SKUs (product codes) and the location code they are stored in, as well as a database storing a mapping between all the barcodes and their associated SKUs. In one embodiment, these may be stored in a single database, or mapped through a relation or other means of mapping between SKUs and barcodes. If the user initiates a search with a barcode, and there are no barcodes stored in a map, the API, upon not being able to locate the barcode, initiates a search in the associated databases for what is searched. If it finds the SKU for the barcode, it attempts to find the SKU in the stored map. If it doesn't find it, it searches in the next database for that SKU for which it will find the associated location code. When it searches the location code, the API will find and return one, and then the user interface highlights that section along with any associated data. Essentially, the tool searches the map and proceeds in turn to search the other databases, or to find a mapping of the search term to data stored in the map. If the identifier is not found anywhere, an error is returned to the user.

A final, optional aspect of this tool is an analytical visualization component. The tool is enabled to receive or query historical or real-time data relating to map locations, SKUs, barcodes, or other information. The system connects this historical or real-time data to what is stored in the plan. The tool manipulates this data based on user input. For example, the tool may allow the user to query sales data in a range from a certain date, may allow the user to be presented the best- or worst-selling products in any location, may allow the user to be presented which locations may need to be restocked soon, or may allow the user to request and be shown historical or real-time data correlated with location. The tool then displays the plan in the necessary way based off the input data and the user's request. Preferably, the display will be color-coded to aid in quick understanding of the visualization.

### Input Methods for Visualization Tool

Scanning-Using a UPC scanner or some other scanning device, the user scans the UPC or any other unique identifying number on a product/component. This is the preferred implementation.

Manual Search—The user manually types in the SKU, UPC or any other unique identifying number. The user must initiate a search, or alternatively the program knows the necessary number of digits and initiates a search once the character limit has been reached. Since most SKU codes have 7 digits and standard UPC codes have 12, when 7 characters and a small pause or 12 characters are added, the input is assumed to be 7 or 12 characters in length, a determination is made as to whether the entry is therefore a SKU or UPC code, and a search is initiated automatically.

Optical Product Recognition-Using a camera attached to or part of the computing device, the user takes a picture of the product/component, or simply brings the product/component into view, and using an image recognition/look-up system, the product/component is identified.

List Selection of Product—With this method, a list or ordered list of the necessary products/components that need to be placed is presented to the user. When the needed item is selected either by mouse or keyboard selection, the component or product is highlighted.

Process of Elimination—In this method, as a user places a product/component, they can inform the system that the component/product has been placed, via the user interface. The displayed plan is then adjusted and highlighted differently based on the remaining components/products.

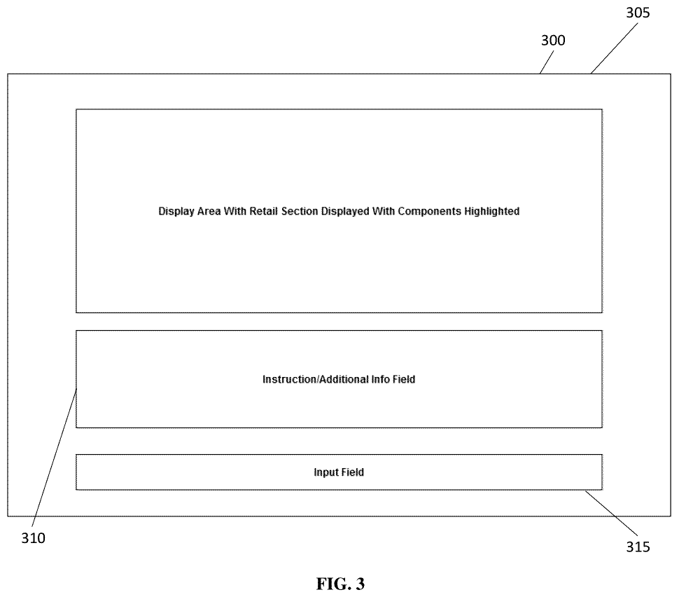

FIG. 3 shows an embodiment of a user interface 300 which may be used with a scanning, manual search or optical product recognition input paradigm. The user inputs the desired code or key into the Input Field 315, or uses scanning or optical product recognition to enter the code or key into the Input Field 315. The Display Area 305 shows the retail section with the selected components highlighted. The Instruction/Additional Info field 310 shows instructions or other information for the user. Other possible user interfaces for these input paradigms may incorporate some similar elements or may provide instructions for specific components and/or products.

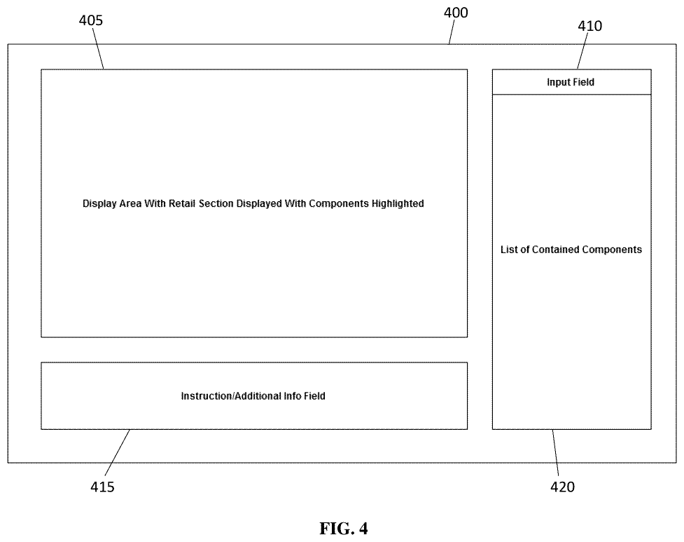

FIG. 4 shows an embodiment of a user interface 400 which may be used with a list selection of product input paradigm. The user selects the item from the List of Contained Components 420 or may enter the information into the Input Field 410. The Display Area 405 shows the retail section with the selected components highlighted. The Instruction/Additional Info field 415 shows instructions or other information for the user. Other possible user interfaces for this input paradigm may incorporate some similar elements or may provide instructions for specific components and/or products.

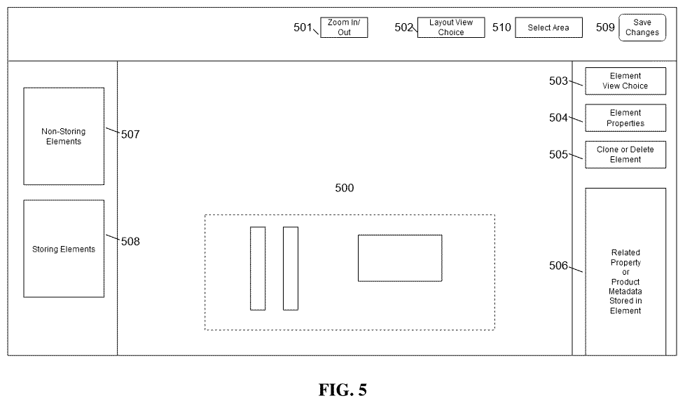

FIG. 5 shows an embodiment of a user interface 500 for a map/plan editor featuring a Zoom In/Out control 501, a Layout View Choice control 502, an Element View Choice control 503, an Element Properties control 504, a Clone or Delete Element control 505, a Related Property or Product Metadata Stored in Element user interface element 506, a Non-Storing Elements list 507, a Storing Elements list 508, a Save Changes control 509 and a Select Area control 510.

### Advanced Aspects

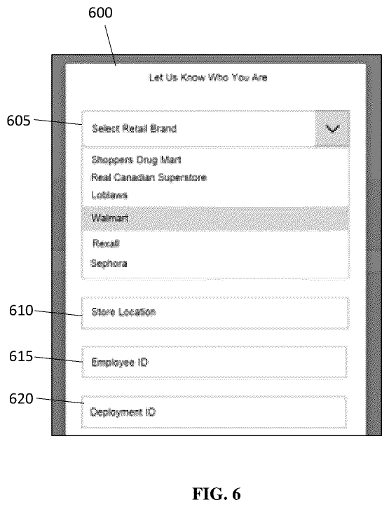

FIG. 6 shows an embodiment of a user interface 600 for signing into the tool. The tool is employed by a merchandiser, the worker tasked with creating or updating the merchandising deployment on a location such as a store shelf. The merchandiser signs into the session on the tool through a user interface 600 similar to the embodiment shown in FIG. 6. This may involve the merchandiser inputting at least some of the retail brand they'll be working in 605, the store location 610, the merchandiser's ID 615, the planogram they are implementing 620, or other information. This information may be used by the system to track the merchandiser's progress and store the results. The results may be used to create and improve deployment session duration estimates, track an individual merchandiser's performance metrics, analyse metrics across deployments, train an AI system for performance tracking or estimation, or some other use. Optionally, the tool may be preloaded with information such that signing in by the user is not required. Optionally, the system may not require any kind of sign-in information.

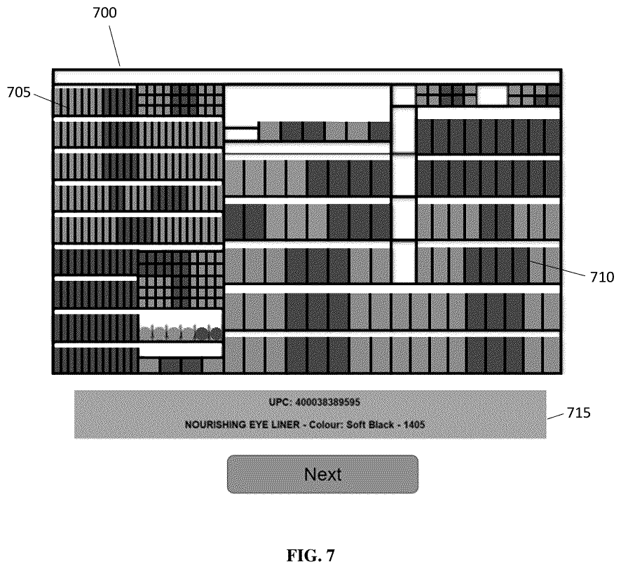

FIG. 7 shows an embodiment of a user interface 700 for the clearing step. Once the optional sign-in process, if any, is completed, if the shelf needs to be modified or cleared, the tool presents a user interface 700 showing which products should be removed. One embodiment of this user interface is shown in FIG. 7. Optionally, colour coding may indicate which shelf locations should remain and which ones should be cleared; in the embodiment shown, a first product 705 and a second product 710 have different intended actions (ie remaining vs removing). Optionally, the user interface may prompt or guide the user through each product to be removed. Optionally, a text box 715 may indicate a product on which to take a specific user action, such as removing or leaving the product. If the deployment is a “new build”, meaning that the shelf is already cleared or does not need specific clearing instructions, this clearing step may be skipped.

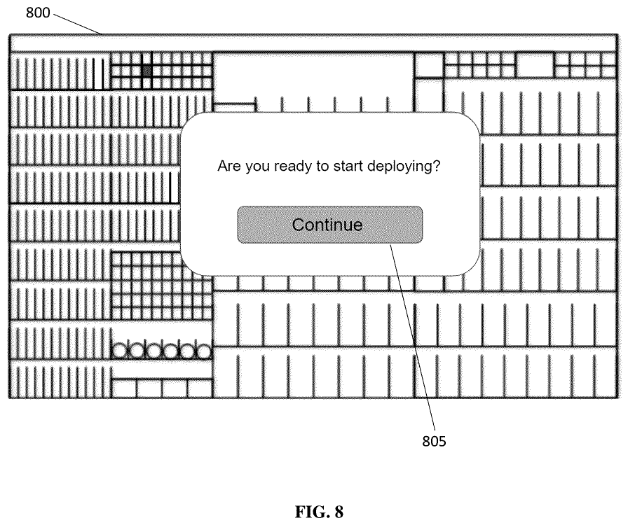

FIG. 8 shows an embodiment of a user interface 800 at the start of deployment. Once the shelf is cleared, or if the shelf was already clear, the tool may be notified that a deployment session is to begin. Optionally, a user interface element 805 may be pressed or engaged to indicate that the deployment session may begin. Optionally, the tool may detect through other means that the shelf is cleared and thus deployment may begin. When the tool is notified that deployment may begin, or determines through other means that deployment may begin, a user interface 800 such as shown in the embodiment in FIG. 8 may be shown to the merchandiser. In this embodiment, the merchandiser selects the Continue button 805, and this action causes the tool to log the start time of the deployment session. Alternately, this action may cause a timer to be started.

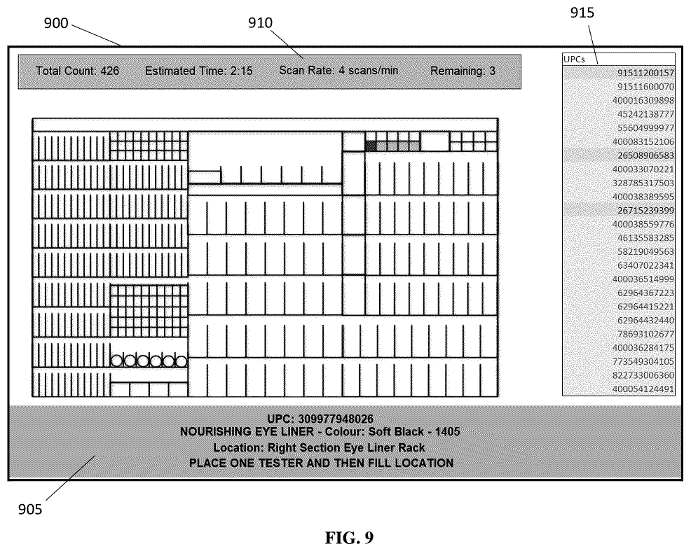

During the deployment session, in one embodiment, the merchandiser scans a product with the tool, and the tool displays a user interface 900 such as the one shown in the embodiment in FIG. 9. Preferably, the user interface 900 displays the destination location for the scanned product by color coding the planogram. Preferably, the user interface 900 also displays a textual location indication 905 along with a command, or user action, which tells the user how to display the product (e.g., “Place an opened tester product and then fill the section.”). Preferably, the system tracks the rate at which products are scanned. Preferably, information about the deployment may be displayed in a status bar 910. Preferably, the user interface 900 shows a color-coded list of UPCs 915 involved in the deployment.

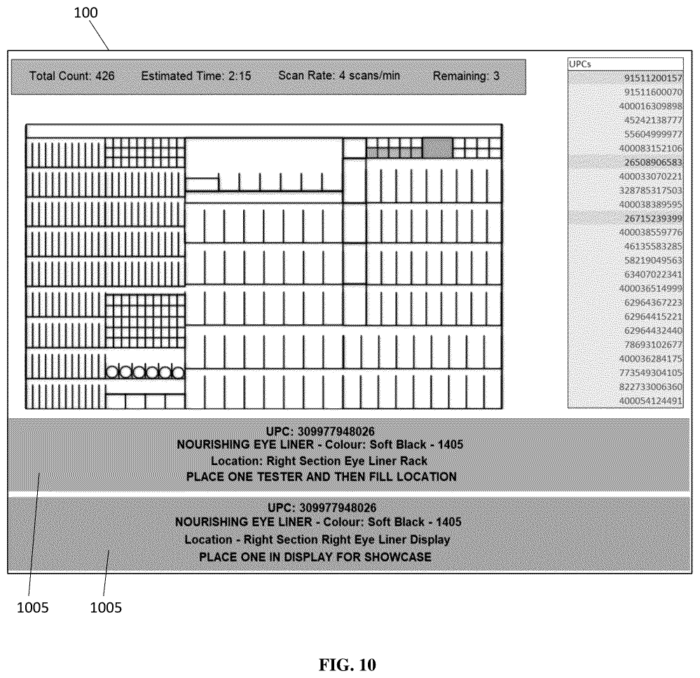

FIG. 10 shows an embodiment of a user interface 1000 with multiple locations or commands. In cases where multiple locations or multiple commands may be required for a specific scanned product, these may be displayed separately on the user interface 1000 in multiple commands 1005, preferably color coded in a consistent fashion such that the colors correspond to specific commands (e.g. a blue coding for “Place one in display for showcase”).

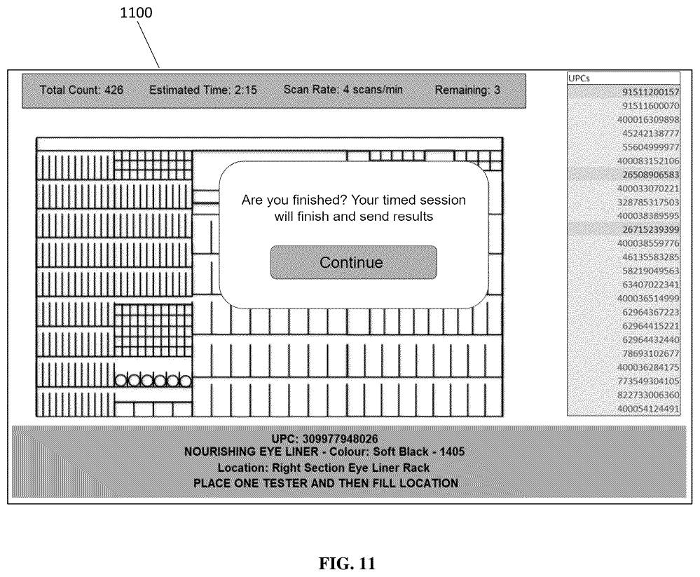

FIG. 11 shows an embodiment of a user interface at the completion of a deployment. Once the shelf deployment is completed, the user may indicate that the deployment is completed by activating a user interface element. Optionally, the tool may detect through other means, such as every required product having been scanned, that the deployment is completed. Preferably, once the tool is notified or determines that the deployment is completed, a user interface 1100 may be shown to confirm the end of the deployment. The ending of the session sets an end-time for the deployment session, or stops the timer which was started at the beginning of the deployment session. If there are any products which were provided in the deployment which were not scanned, the system may note these and compile a report of missing products.

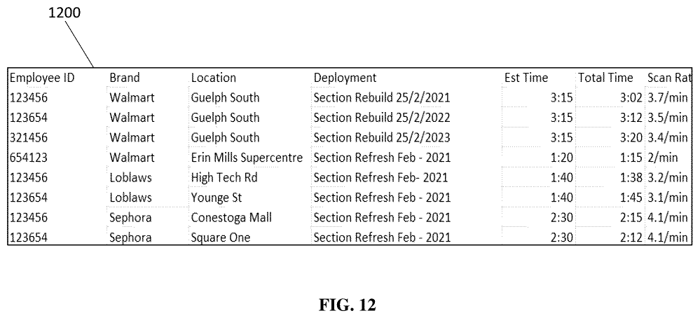

Preferably, the creation of this report may also flag products to be shipped to the deployment location to complete the deployment. Optionally, the creation of this report may also automatically order the products to be shipped to the retailer. One sample embodiment of the report 1200 is shown in FIG. 12. Preferably, the system adds at least some of timing statistics (such as estimated or actual duration of merchandising deployment or time of deployment), location information, merchandiser information, brand information, details of the deployment, or other information related to the deployment, to the report. Preferably, the report may be exportable to other formats for tracking and analysis purposes. Preferably, the contents of the report, and the tracked data, are available for the analytical and visualization systems disclosed in the previous disclosure.

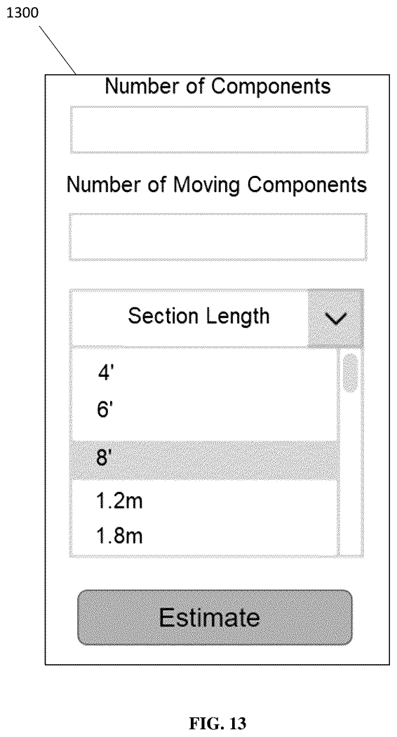

The system may allow the deployment controller to access a user interface similar to the embodiment 1300 shown in FIG. 13. The system may correlate information from multiple deployments, including duration of deployment session, to estimate the time needed for future deployments. A crude estimate would be a simple average of all deployment session durations for a given merchandising selection. More accurate estimates may use standard statistical tools, remove outlier data, incorporate information about the deployment being estimated, or use other techniques.

### Notes Feature

Often a deployment may benefit from notes made to the merchandiser. Such notes may provide technical updates (e.g. “Move fixture bracket at upper-right to avoid blocking signage”), product information (e.g. “Note that Dark Red and Ruby are different but very similar in packaging”), presentation information (e.g. “Ensure that shaving cream labels show the image to the front of the display”), supply information (e.g. “Supplier has changed label-you may see two different-looking packages for the same product”), or any other information that a merchandiser may need to know or be reminded of at the beginning of deployment. Depending on the nature of the comments, the notes may initially originate from a previous merchandiser who encountered a situation, or from the merchandising controller who anticipates supply or other issues.

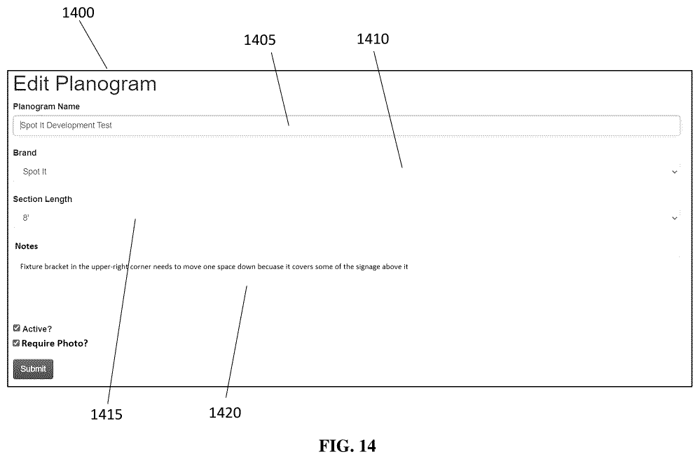

FIG. 14 shows an embodiment of a user interface 1400 for a controller to edit or create a new planogram, with the ability to enter one or more notes for the merchandiser to see when the merchandiser starts the deployment. Fields such as planogram name 1405, brand 1410, section length 1415 and the notes for the merchandiser 1420 may be included in the user interface 1400.

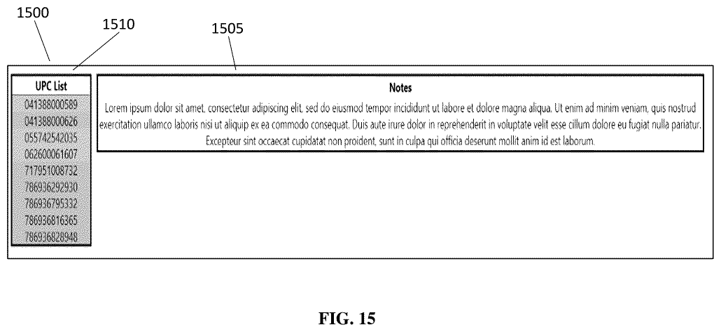

FIG. 15 shows an embodiment of a user interface 1500 for showing the tool's user (the merchandiser) a note 1505. The note 1505 may be shown as soon as the tool is opened, when the deployment session is started, when a particular barcode or product is scanned for placement, or whenever some other trigger event occurs. Preferably, a UPC List 1510 shows with which item or items, identified by UPC code, the note 1505 is linked. Preferably, multiple notes 1505 may be attachable to a single planogram, and each may be triggered by a different trigger event. Preferably, the notes 1505 may be accessed through the user interface independent of the trigger event. Optionally, the controller may be able to attach the same note 1505 to multiple deployment planograms (e.g., a note indicating “Be aware that Walmart deployments are 10 cm shorter than other deployments” may be attached to all Walmart-located deployments).

In one embodiment, the tool may prompt the merchandiser to enter a comment about the deployment. Preferably, the prompt would come at the end of the deployment session, so that the merchandiser will have full knowledge and immediate recollection of any issues encountered during the deployment. Preferably, the user interface also has a control which may enable the entering of a comment at any time. Preferably, multiple comments may be enabled for a single deployment session. Following the deployment session, the comments are sent to the merchandising controller, who may enter it into the main notes for other merchandisers performing the same or a similar deployment, may modify the comments for others' use, or may use the comments for any other purpose.

### Photo Capture

A photo of a completed deployment may be used to correlate the current deployment with other same or similar deployments, and for auditing.

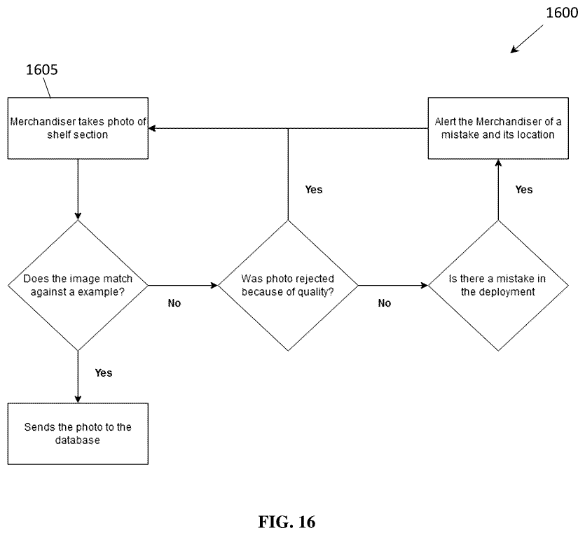

In one embodiment, the tool may request or require the merchandiser to take a picture of the finished deployed shelf with the tool or with a communicatively attached device. Following the flowchart 1600 in FIG. 16, beginning at the upper left 1605, the merchandiser takes a photo of the shelf section, and the photo is sent to the main system, preferably through a wireless link. The system attempts to match the photo against a sample image of a correct deployment. If the system detects a match, the photo is added to the database of correct deployments, and the merchandiser is notified that the deployment is correct and complete. If the system does not detect a match because the image quality is too poor, the photo is rejected, and the tool indicates to the merchandiser that the merchandiser must re-take the photo. If the system does not detect a match despite good image quality, the system analyzes the image against the reference image, identifies where the mismatch exists, optionally highlights the discrepancies on the submitted photo, and notifies the merchandiser of the error in deployment. The merchandiser may then correct the deployment and re-take the photo.

If the system detects a mismatch, but the deployment was done correctly, the merchandiser may activate a user interface control to indicate that the deployment is correct. In this case, the system may override its mismatch detection and add the photo to the database of correct deployments. Preferably, the system may also alert the merchandising controller that a new photo was added which does not conform to the set expectations.

When the system detects that the deployment is correct, the photo of the deployment may be added to the report generated for that deployment. Optionally, the photo may be used to audit that the deployment was completed and was correct.

Optionally, an artificial intelligence or machine learning system may be used to check the image.

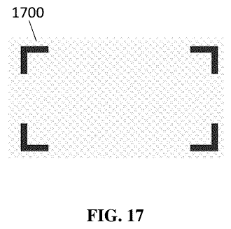

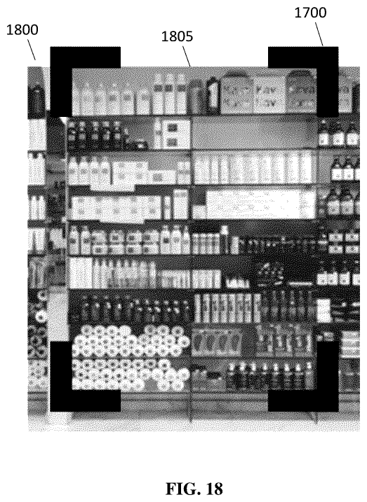

FIG. 17 shows an example of a user interface overlay 1700 such as may be used when photographing the deployment, for framing the deployment for image capture. FIG. 18 shows an example of this overlay 1700 in use, overlaid on top of a live camera image 1805, in one embodiment of a user interface 1800 for image capture.

### Maintenance Tool

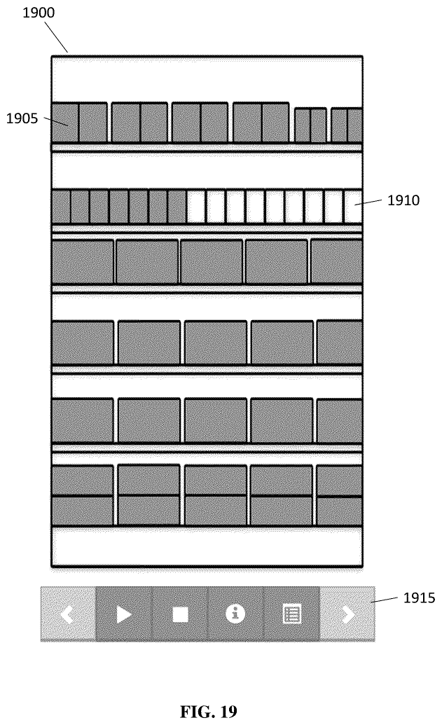

FIG. 19 shows an exemplary implementation of the user interface 1900 for the maintenance tool. A maintenance tool may be a separate software application or may be a different mode of operation of the merchandising tool. This tool allows an agent to check or audit a shelf for correct deployment. Upon an agent activating the maintenance tool, whether by explicitly launching the maintenance tool, by selecting the maintenance tool mode in a screen of the merchandising tool, or by having the maintenance tool mode automatically selected upon the agent logging in to the maintenance tool, the view of the deployed shelf indicates, through colour-coding or some other means, which products should be checked. Multiple colours or codings may be used in the view of the shelf, to indicate different intended actions, or deployment situations, for each coding. For example, a first product 1905 is differentiated from a second product 1910 through colour or shade coding. A control bar user interface element 1915 allows for quick access to certain tool features, like moving to a next or previous deployment, showing additional information on the deployment currently displayed, showing and/or hiding notes for the current deployment, or any other commonly needed action.

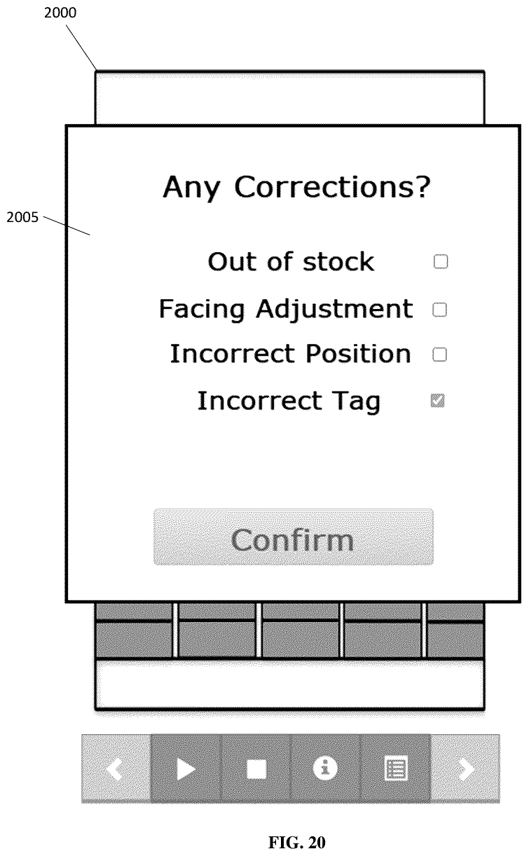

FIG. 20 shows an exemplary user interface 2000 used to ascertain from the user whether the scanned product was correctly deployed. Scanning a product in this tool brings up a user interface element 2005 asking which corrections, if any, need to be made to the product on the shelf. This allows the agent to quickly note any errors in deployment. The tool records all errors in deployment in a database or similar logging system. As the system tracks all products which must be part of the deployment, any product which is expected to be part of the deployment, but which is not scanned may be flagged as missing. The tool may also track coupon levels for any product currently being promoted.

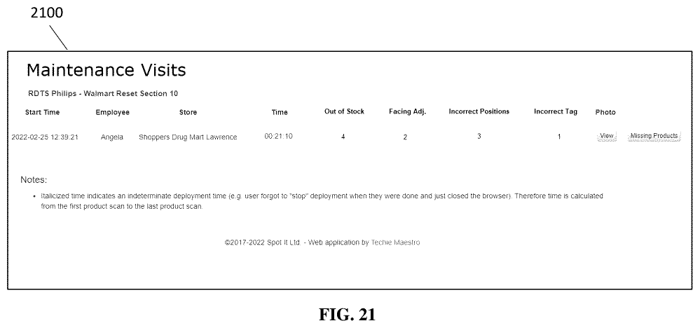

FIG. 21 shows an exemplary report 2100 generated by the system. Data associated with the audit, including any changes made to any product in the deployment as well as a log of which products were correctly deployed, is logged in a database or similar logging system. This system may be queried, through an administration portal or other feature of the tool and may generate a report based on product or on deployment, or on audit work or corrections performed during an audit visit. Other refining criteria, such as location of deployment, may also be specified.

According to the disclosure, a system for viewing planograms is disclosed. The system comprises a handheld planogram visualization tool whereby the tool comprises a visual user interface. The system further comprises a database system, which stores stock information. The user interface of the system is enabled to highlight needed product changes in a deployment. The database system is enabled to generate a deployment report and the time taken to complete a deployment is stored in the database.

According to the disclosure, the user interface is enabled to receive user input of a product identifier for product selection, and the user interface highlights the location in the planogram of the product corresponding to the received product identifier.

According to the disclosure, the handheld planogram visualization tool additionally comprises an optical scanner, wherein the handheld planogram visualization tool is enabled to recognize a scanned product code as input for product selection within the visualization tool. The user interface is enabled to show a user action required for a product and the user interface is enabled to show a note.

According to the disclosure, a method for visualizing planogram data on a handheld device is also disclosed. The method comprises the steps of receiving user input of a product identifier, calculating a user action based on the received product identifier, and updating the user interface to indicate the user action. The user input is an optically scanned product code. The user input is a manually inputted product code. The user action is one of removing the identified product from a display, adding the identified product to a display, or leaving the identified product on the display.

According to the disclosure, a system for auditing merchandising deployments is also disclosed. The system comprises a handheld device with a visual user interface, wherein the handheld device is enabled to display on the user interface a color-coded planogram, and wherein the user interface is enabled to receive user input of a product identifier for product selection, and wherein the user interface highlights the location in the planogram of the product corresponding to the received product identifier. The system of further comprises an optical scanner, wherein the handheld device is enabled to recognize a scanned product code as input for product selection within the auditing system.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code, or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

1. A system for viewing planograms, comprising:
a database system which stores stock information and is enabled to generate a report of metrics related to a deployment; and
a handheld planogram visualization tool, the tool further comprising:
a processor;
a visual user interface; and
an optical scanner;
wherein the user interface is enabled to receive user input of a product identifier for product selection, and wherein the user interface highlights the location in the planogram of the product corresponding to the received product identifier;
wherein the user interface is enabled to highlight needed product changes in a deployment;
wherein the handheld planogram visualization tool is enabled to recognize a scanned product code as input for product selection within the visualization tool;
wherein the handheld device is enabled to recognize a scanned product code as input for product selection within the auditing system.

2. (canceled)

3. (canceled)

4. (canceled)

5. (canceled)

6. The system of claim 1, wherein the tool's user interface is enabled to show a user action required for a product.

7. The system of claim 1, wherein the tool's user interface is enabled to show a note.

8. The system of claim 1, wherein the database system is enabled to generate a deployment report.

9. The system of claim 1, wherein the time taken to complete a deployment is stored in the database.

10. A method for visualizing planogram data on a handheld device, comprising the steps of receiving user input of a product identifier, calculating a user action based on the received product identifier, and updating the user interface to indicate a user action the user actions comprising one of removing the identified product from a display, adding the identified product to a display, or leaving the identified product on the display.

11. The method of claim 10, wherein the user input is an optically scanned product code.

12. The method of claim 10, wherein the user input is a manually inputted product code.

13. (canceled)

14. (canceled)

15. (canceled)

16. The system of claim 1, wherein the tool is enabled to digitally photograph the completed deployment.

17. The system of claim 1, wherein the database is enabled to receive from the tool at least one of a deployment metric or a digital photograph of the completed deployment.

18. The system of claim 17, wherein the database is enabled to analyze at least one of a deployment metric or a digital photograph of the completed deployment, and calculate at least one metric to measure the accuracy or efficiency of the deployment.

19. The system of claim 17, wherein the database is enabled to generate a deployment report of the completed deployment, showing the at least one metric generated by the database.

20. The system of claim 17, wherein the database is enabled to aggregate any relevant deployment durations stored in the database and calculate at least one metric related to predicted or historical deployment durations.
